(19) United States
(12) Patent Application Publication
(10) Pub. No.: US 2017/0318552 A1
(43) Pub. Date: Nov. 2, 2017

(54) METHOD OF ATTACHING A USER EQUIPMENT TO A BASE STATION OF A TELECOMMUNICATIONS SYSTEM

(71) Applicant: AIRBUS DS SLC, Elancourt (FR)

(72) Inventor: Laurent PISON, Jouars Ponchartrain (FR)

(21) Appl. No.: 15/498,879

(22) Filed: Apr. 27, 2017

(30) Foreign Application Priority Data
Apr. 27, 2016 (FR) 1653722

(51) Int. Cl. H04W 60/00; H04W 12/06; H04W 8/02

(52) U.S. Cl. CPC H04W 60/00; H04W 8/02; H04W 12/06

(57) ABSTRACT

A method for attaching a user piece of equipment to a first base station of a wide-band telecommunications system, the first base station including a first mobility management module identified by a first identifier, the method including a step of receiving an attachment request, sent by the user piece of equipment, including a second identifier of a mobility management module and, when the second identifier is identical to the first identifier, a step of attaching the user piece of equipment to the first base station.

### TECHNICAL FIELD AND OBJECT OF THE INVENTION

The present invention relates to the telecommunications field and more particularly relates to a method for attaching a user piece of equipment to a base station of a telecommunications system as well as a user piece of equipment, a base station, a telecommunications system comprising such a user piece of equipment and such a base station, and a computer program.

### STATE OF THE ART

Private mobile radiocommunications (PMR) networks are used in particular by security force professionals (army, police, ambulance, fireman . . . ), building companies, public works or even industry. Such networks are closed networks using dedicated resources, that is only a group of predetermined user equipment can use these resources in order to communicate with each other.

From PMR networks, so-called “narrow-band” PMR and so-called “wide-band” PMR networks are to be distinguished. The narrow-band PMR networks use a plurality of low width dedicated frequency bands and can be, for example, Tetra, Tetrapol or P25 type PMR networks known to those skilled in the art. The narrow-band PMR networks are limited in pass-band, because of the restricted number of available frequency resources, and thus only allow the transmission of voice communications or low rate data. By way of example, it is not possible to transmit a video communication between two user piece of equipment through such a network.

Nowadays, a telecommunications system is known, working in narrow frequency bands, used in particular in military applications, comprising a plurality of mobile base stations to each of which a plurality of mobile user piece of equipment is attached. Each user piece of equipment is only associated to one and only one predetermined base station so as to form with it a stand-alone mobile cell. Each hand-alone cell thus constitutes an independent narrow-band PMR network, using for example distinct frequency bands to communicate. By way of exception, a user piece of equipment associated with a first base station can be connected to a second base station to communicate in case of urgency or if the first base station to which it is associated is connected by a temporary direct communication link with the second base station.

Wide-band PMR networks use at least one wide frequency band in which signals from a plurality of low width dedicated frequency bands are frequency-modulated so as to spread their spectrum on at least one part of the width of the wide band. Such a modulation enables data to be exchanged at high rates, for example higher than 1 Mb/s, in order in particular to communicate by video or to send data files. Such wide-band networks can, for example, be Universal Mobile Terrestrial Communication (UMTS) or Long Term Evolution (LTE) type networks defined within the scope of the Third Generation Partnership Project (3GPP).

In wide-band communication networks, for example of the 3GPP LTE type, user piece of equipment are not associated with a predetermined base station and can be attached indiscriminately to any base station of the network. Thus, when a user piece of equipment desires to be attached to a base station to communicate, it sends an attachment request, via one of the base stations, to a resource allocation entity located in the network which then selects the most suitable base station for the user piece of equipment to be able to establish a communication, for example the base station whose signal received by the user piece of equipment is the strongest or the base station which has available the greatest number of available pass-band resources.

The attachment of a user piece of equipment to a base station as defined today in wide-band networks such as, for example, 3GPP LTE networks, is therefore not compatible with a telecommunications system with stand-alone cells working in narrow frequency bands as previously set out since in such a system, a user piece of equipment has to be attached to the base station with which it is associated whereas, in a wide-band network, a user piece of equipment is attached to a base station which is selected by a resource allocation entity located in the network.

To date, there is no wide-band PMR telecommunications system with stand-alone cells and the invention thus has the object to overcome this lack.

### GENERAL DISCLOSURE OF THE INVENTION

To that end, one object of the invention is first a method for attaching a user piece of equipment, preferably a mobile one, to a first base station of a wide-band telecommunications system, said method being remarkable in that, the first base station comprising a first mobility management module identified by a first identifier, the method comprises a step of receiving an attachment request, sent by said user piece of equipment, comprising a second identifier of a mobility management module and, when the second identifier is identical to the first identifier, a step of attaching the user piece of equipment to the first base station.

By the terms “attached”, “attaching” and “attachment”, it is intended that the user piece of equipment is authorised to be connected to the first base station to communicate applicative data. By the terms “applicative data”, it is intended data exchanged within the scope of an application such as, for example, a voice, video communication application, a file exchange application, etc.

Thus, a base station is associated with one or a plurality of predetermined user piece of equipment which are authorised to be attached to said base station by using an identifier corresponding to the identifier of its mobility management module. Besides, a user piece of equipment is associated with one and only one base station, that is a user piece of equipment only sends attachment requests comprising the identifier of the base station with which it has been previously associated. Each base station and its associated user piece of equipment thus make up a stand-alone cell, preferably, a mobile one, the base station being further possibly connected to another base station via a direct communication link or via a wide-band telecommunications network.

Advantageously, the attachment step comprises authenticating the user piece of equipment.

According to one aspect of the invention, the attachment of the user piece of equipment to the first base station is denied when the second identifier is different from the first identifier.

According to another aspect of the invention, the attachment of the user piece of equipment to the first base station is authorised when the second identifier is different from the first identifier and the first base station is connected via a communication link, preferably an Internet protocol (IP) type communication link known to those skilled in the art, to a second base station comprising a second mobility management module identified by a third identifier, identical to the second identifier. In this case, the attachment step can comprise a sub-step of authorising access and/or authenticating the user piece of equipment from the second mobility management module.

According to another aspect of the invention, the attachment request further comprises a piece of information about the urgent or non-urgent nature of the attachment request, and the attachment of the user piece of equipment to the first base station is authorised when the second identifier is different from the first identifier and the attachment request is of an urgent nature. The urgent nature of the request indicates that the user piece of equipment has to be attached to the first base station while it is not associated with said first base station (but to another base station) and thus it is not authorised to be attached to the first base station when the nature of the attachment request is non-urgent. Such an urgency case can happen, for example, when the user piece of equipment needs to establish an urgency call whereas it is not in the cell coverage of the base station with which it is associated and it is in the cell coverage of the first base station.

The base station is preferably a mobile base station but can also be a fixed base station.

Advantageously, the method comprises a preliminary step of selecting an operating mode from an operating mode in a stand-alone mobile cell for which the method as previously set out is implemented, or an operating mode in a wide-band telecommunications network in which the first base station is connected via said network to a plurality of base stations, for example fixed stations, and authorises any user piece of equipment to be attached, for example depending on its proximity or the available pass-band resources. The latter operating mode in a network corresponds, for example, to the operation of a 3GPP UMTE or public LTE (i.e. commercial) network. Thus, in this operating mode, the telecommunications network is preferably a UMTS, LTE, LTE-Advanced or subsequent type 3GPP network.

The invention also relates to a method for attaching a user piece of equipment, preferably a mobile one, to a base station of a wide-band telecommunications system, said method being remarkable in that, said base station comprising a mobility management module, the method comprises a step of sending, by said user piece of equipment, an attachment request comprising an identifier of said mobility management module so as to attach the user piece of equipment to the base station.

According to one embodiment, the method comprises a step of generating from the user piece of equipment a request comprising at least one piece of information about the non-urgent or urgent nature of the communication, a step of sending from the user piece of equipment said request to the base station and a step of receiving a reply message sent by the base station, said reply message indicating that the attachment is made when the communication is urgent or comprising a confirmation piece of information of the attachment state when the communication is non-urgent.

The invention also relates to a user piece of equipment comprising a radiocommunication unit, configured to communicate with a radiocommunication module of a base station of a wide-band telecommunications system, and an attachment unit, configured to generate an attachment request to a base station comprising a second identifier of a mobility management module and to send it to said base station, via the radiocommunication unit, for the purpose of attaching the user piece of equipment to the base station.

According to a preferred aspect of the invention, the user piece of equipment comprises an applicative unit configured to exchange applicative data with an applicative module of a base station,

The invention also relates to a base station of a wide-band telecommunications system, said base station being remarkable in that it comprises a mobility management module identified by a first identifier and a radiocommunication module configured to receive, from a user piece of equipment, an attachment request comprising a second identifier of a mobility management module, the mobility management module being configured to, when the second identifier is identical to the first identifier, attach the user piece of equipment to the base station.

Preferably, the communication module of the base station is advantageously an eNodeB.

According to one characteristic of the invention, the base station comprises a user data module, connected to the mobility management module, configured to store and manage data associated with user piece of equipment so as to authorise or not their attachment to the base station.

According to one aspect of the invention, the base station further comprises a serving gateway module, a network gateway module and/or an applicative module, said serving gateway module being configured to route that is steer, data packets between the network gateway module for data packets and the radiocommunication module, said network gateway module for data packets being configured to communicate data packets with an entity external to the base station via a communication link, said applicative module being configured to exchange applicative data with an applicative unit of a user piece of equipment.

The invention also relates to a system comprising at least one user piece of equipment as previously set out and at least one base station as previously set out.

The invention also relates to a computer program including instructions for implementing the method of the invention implemented by a base station when the program is run by at least one processor.

The invention also relates to a computer program including instructions for implementing the method of the invention implemented by a base station when the program is run by at least one processor.

Further characteristics and advantages of the invention will appear upon reading the description that follows made with regard to the appended figures given by way of non-limiting examples and in which identical references are given to similar objects.

### DESCRIPTION OF THE FIGURES

FIG. 1 illustrates one embodiment of the system according to the invention.

FIG. 2 illustrates an example of a common cell.

FIG. 3 illustrates one embodiment of the base station according to the invention.

FIG. 4 illustrates one embodiment of the user piece of equipment according to the invention.

FIG. 5 is a flowchart illustrating a mode of implementing the method according to the invention.

### DETAILED DESCRIPTION OF THE INVENTION

### I. System 1

The system according to the invention is described hereinafter within the scope of an infrastructure of a 3GPP LTE network. However, that is not limiting the scope of the present invention insofar as the invention is applicable to any type of suitable telecommunications network such as, for example, a 3GPP UMTS network, a LTE-Advanced network or even a GPRS or GSM type network.

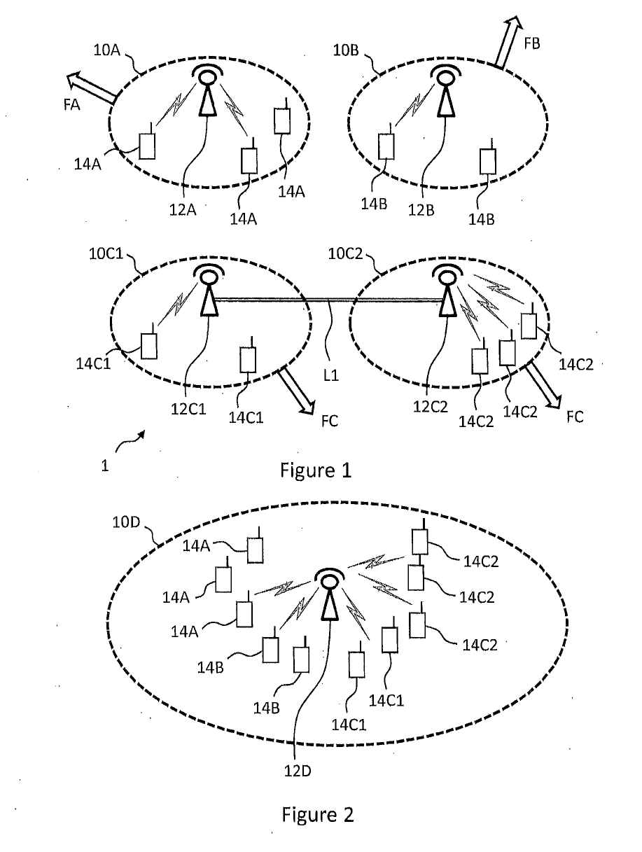

FIG. 1 illustrates one embodiment of the telecommunications system 1 according to the invention. The system 1 comprises a first mobile cell 10A, a second mobile cell 10B, a third mobile cell 10C1, a fourth mobile cell 10C2 and a fifth fixed cell 10D (illustrated by FIG. 2), all belonging to a same network identified by a network identifier (Public Land Mobile Network Identifier).

The first mobile cell 10A comprises a first mobile base station 12A to which a first plurality of mobile user piece of equipment 14A is attached.

Likewise, the second mobile cell 10B comprises a second mobile base station 12B to which a second plurality of mobile user piece of equipment 14B is attached.

The first mobile cell 10A and the second mobile cell 10B make up stand-alone mobile cells which operate independently of each other and which can, for example, be moved in a direction FA and in a direction FB respectively.

The third mobile cell 10C1 comprises a third mobile base station 12C1 to which a third plurality of mobile user piece of equipment 14C1 is attached and the fourth mobile cell 10C2 comprises a fourth mobile base station 10C2 to which a fourth plurality of mobile user piece of equipment 14C2 is attached. The third mobile base station 12C1 and the fourth mobile base station 10C2 are connected by a communication link L1, for example of the IP type, such that a user piece of equipment of the third plurality of user piece of equipment 14C1 can be attached to the fourth base station 12C2 to communicate with the third mobile cell 10C1 via the communication link L1 and/or that a user piece of equipment of the fourth plurality of user piece of equipment 14C2 can be attached to the third base station 12C1 to communicate with the fourth mobile cell 10C2 via the communication link L1. The third mobile cell 10C1 and the fourth mobile cell 10C2 make up stand-alone mobile cells which operate independently of each other while being bounded, via the communication link L1, and which can, for example, be moved together in a direction FC.

The fifth fixed cell 10D, illustrated in FIG. 2, comprises a fifth, fixed, base station 12D, to which the first plurality of user piece of equipment 14A, the second plurality of user piece of equipment 14B, the third plurality of user piece of equipment 14C1 and/or the fourth plurality of user piece of equipment 14C2 can be attached, for example when they are in the cell coverage of the fifth, fixed, base station 10D and that the first mobile base station 10A, the second mobile base station 106, the third mobile base station 10C1 and/or the fourth mobile base station 10C2 are deactivated.

By way of example, the first base station 12A, the second base station 12B, the third base station 12C1 and the fourth base station 12C2 can be mounted in mobile vehicles whereas the fifth base station 12D can be mounted to a building or a temporary structure.

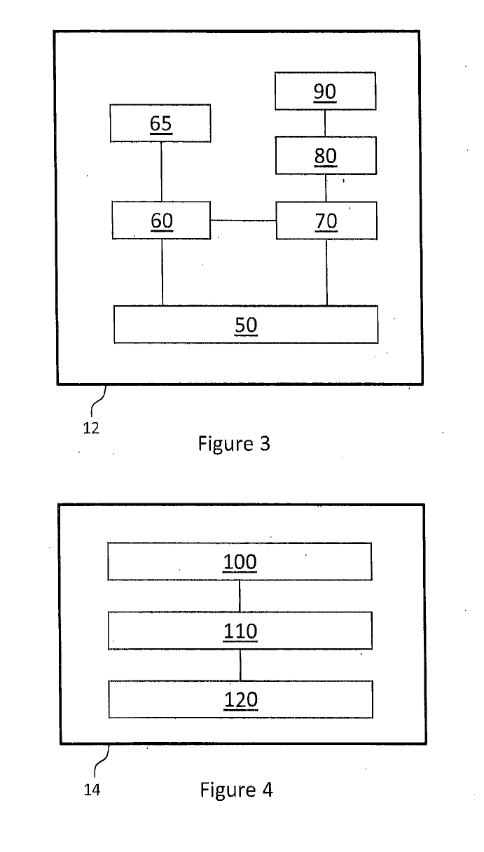

The first base station 12A, the second base station 12B, the third base station 12C1 and the fourth base station 12C2 are functionally described hereinafter in reference to a base station 12 illustrated in FIG. 3. Likewise, the user piece of equipment 14A, 14B, 14C1 and 14C2 are functionally described hereinafter in reference to a user piece of equipment 14 illustrated in FIG. 4.

### a) Base Station 12

FIG. 3 schematically illustrates one embodiment of a base station 12 according to the invention. Such a base station 12 is in the form of a node comprising a radiocommunication module 50, a mobility management module 60, a user data module 65, a serving gateway module 70, a network gateway module 80 for data packets and an applicative module 90.

### i) Radiocommunication Module 50

The radiocommunication module 50 makes up an entity known as “eNodeB” in the 3GPP LTE terminology.

The radiocommunication module 50 is configured to allow one or a plurality of applicative data communications between the applicative module 90 and one or a plurality of user piece of equipment 14 attached to the base station 12.

According to the invention, the radiocommunication module 50 is further configured to receive an attachment request to the base station 12, sent by a user piece of equipment 14.

### Mobility Management Module 60

The mobility management module 60 of a base station 12 is characterised by a first, single, identifier which is peculiar thereto such that only the user piece of equipment 14 which are aware of this first identifier can ask to be attached to this base station 12.

The mobility management module 60 is configured to manage the mobility of a user piece of equipment 14 depending on the mobility management function defined in the 3GPP standards as “MME” (Mobile Management Entity) known to those skilled in the art.

More precisely, the mobility management entity MME 60 is configured to establish and control the LTE bearers between the radiocommunication module 50, the serving gateway module 70, the network gateway module 80 for data packets and the user piece of equipment 14 in order to communicate applicative data packets between the user piece of equipment or the user equipment 14 attached to the base station 12 and the applicative module 90.

In particular, the mobility management entity MME 60 controls the communications of the user piece of equipment 14 between the radiocommunication module 50 and the serving gateway module 70.

According to the invention, the mobility management module 60 is configured to allow the attachment of a user piece of equipment 14 to the base station 12 when a second identifier, sent in an attachment request by said user piece of equipment 14 to said base station 12 via the radiocommunication module 50, corresponds to a first identifier of the mobility management module 60 of the base station 12.

The mobility management module 60 enables in particular a user piece of equipment 14 to be authenticated: indirectly, from the user data management module 65 during a first attachment request sent by a user piece of equipment 14, or directly, for a user piece of equipment 14 already attached to the base station 12.

iii) User Data Management Module 65

Likewise, the user data module 65 is configured to store and manage data associated with the user piece of equipment 14 authorised to be attached to the base station 12 via the radiocommunication module 50 and the mobility management module 60 depending on the function of the user data base defined in the 3GPP standards as “HSS” (Home Subscriber Server) known to those skilled in the art.

Data from the user data module 65 enable the mobility management module 60, from a second identifier, received from a user piece of equipment 14 in an attachment request, to authorise, or not, the attachment of said user piece of equipment 14 to the base station 12.

Data from the user data module 65 can, for example, be authentication keys, information about rights of the user piece of equipment, etc.

### iv) Serving Gateway Module 70

The serving gateway module 70 is configured to route, that is steer, data packets between the network gateway module 80 for data packets and the radiocommunication module 50 according to the routing function defined in the 3GPP standards as “SGW” (Serving Gateway) known to those skilled in the art.

### v) Network Gateway Module 80 for Data Packets

The network gateway module 80 for data packets is an access point configured to communicate data packets with the applicative module 90 via a communication link, for example of the Internet Protocol (IP) type, according to the routing function defined in the 3GPP standards as “PGW” (Packet Data Network Gateway) known to those skilled in the art

### vi) Applicative Module 90

The applicative module 90 is configured to manage applications, for example, of the “push-to-talk” voice communication type or video communication type, known to those skilled in the art, used by the user piece of equipment 14, in particular by communicating applicative data with said user piece of equipment 14.

vii) Communication Link L1

In the example of FIG. 1, the third mobile base station 12C1 is connected to the fourth mobile base station 12C2 via a communication link L1.

This communication link L1 can be an IP-IP communication link made at the applicative level above the network gateway modules 80 for data packets of the third base station 12C1 and the fourth base station 12C2.

This communication link L1 can also be a communication link between the network gateway module 80 for data packets of the third base station 12C1 and the serving gateway module 70 of the fourth base station 12C2 or even a communication link between the network gateway module 80 for data packets of the fourth base station 12C2 and the serving gateway module 70 of the third base station 12C1 (interface S5 of the 3GPP LTE standard).

Preferably, this communication link L1 is a communication link between, on the one hand, the radiocommunication module 50 of the third base station 12C1 and, on the other hand, the mobility management module 60 and the serving gateway module 70 of the fourth base station 12C2 or even a communication link between, on the one hand, the radiocommunication module 50 of the fourth base station 12C2 and, on the other hand, the mobility management module 60 and the serving gateway module 70 of the third base station 12C1 (interface S1 of the 3GPP LTE standards). In this case, the radiocommunication module 50 of the third base station 12C1 (respectively of the fourth base station 12C2) can thus advantageously access both the mobility management module 60 of the third base station 12C1 and the fourth base station 12C2 (respectively of the fourth base station 12C2 and the third base station 12C1) in order to check that the first identifier provided by a user piece of equipment 14 corresponds to a mobility management module 60 accessible thereto.

### b) User Piece of Equipment 14

FIG. 4 schematically illustrates a user piece of equipment 14 according to the invention. Such a user piece of equipment 14 comprises a radiocommunication unit 100, a unit 110 for attaching to a base station 12 and an applicative unit 120.

The radiocommunication unit 100 is configured to communicate, on an eUTRAN radio interface defined in the LTE standard, with the radiocommunication module 50 of a base station 12.

According to the invention, the attachment unit 110 is configured to generate an attachment request to a base station 12 and send it, via the radiocommunication unit 100, for the purpose of attaching the user piece of equipment 14 to said base station 12. Such an attachment unit 110 can for example be implemented by radio resource control (RRC in 3GPP terminology).

The applicative unit 120 is configured to manage applications, for example, of the “push-to-talk” voice communication or video communication type, known to those skilled in the art, in particular by communicating applicative data with a base station 12.

### II. Implementation of the Invention

The method according to the invention can comprise a preliminary step of selecting an operating mode from an operating mode in a stand-alone mobile cell or an operating mode in a wide-band telecommunications network.

In the operating mode in a wide-band telecommunications network, a first base station is connected via said network to a plurality of base stations, for example fixed ones, and authorises any user piece of equipment to be attached, for example as a function of its proximity or the available pass-band resources.

The latter operating mode in a network corresponds, for example, to the standard operation of a 3GPP UMTS or public LTE (i.e. commercial) network, as is defined in the 3GPP standard mainly in specification TS 36.300 (eUTRAN overall description—Stage2), as well as in the specification TS23.401 (GPRS enhancement for eUtran).

In this operating mode, the wide-band telecommunications network is preferably a UMTS, LTE, LTE-Advanced or subsequent type 3GPP network.

### a) EXAMPLE 1

### Attachment of a User Piece of Equipment to its Reference Base Station

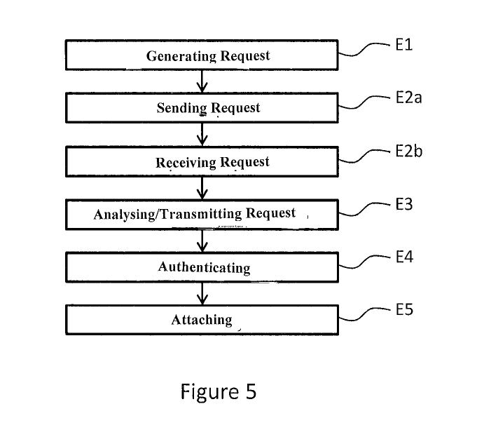

FIG. 5 illustrates a mode of implementation of the method according to the invention by a base station 12A of a stand-alone cell 10A (in reference to FIG. 1) not bounded to another cell and in the case of a non-urgent communication. The mobility management module 60 of said base station 12A is identified by a first identifier.

In a step E1, the attachment unit 110 of the user piece of equipment 14A generates an attachment request comprising a second identifier of a mobility management module in order to be attached to the base station 12A.

The attachment request thus generated is sent, in a step E2a, by the radiocommunication unit 100 of the user piece of equipment 14A to the radiocommunication module 50 of the base station 12A which receives it in a step E2b.

Once the attachment request is received by the user piece of equipment 14A, the radiocommunication module 50 analyses the second identifier and transmits the attachment request to the mobility management module 60 of the base station 12A when the second identifier is identical to the first identifier in a step E3.

The mobility management module 60 then allows, in a step E4, the user piece of equipment 14A to be authenticated in order to authorise it to be attached to the base station 12A in a step E5.

At the first attachment of the user piece of equipment 14A, the mobility management module 60 relays the attachment request from the user piece of equipment 14A to the user data management module 65 which then performs authentication of the user piece of equipment 14A (which is transparent to the mobility management module 60 and the radiocommunication module 50) in a manner known to those skilled in the art. If this first authentication is properly made, then the mobility management module 60 receives keys derived to the user data management module 65 which will be used for the future communications with the user piece of equipment 14A. Thus, each time the user piece of equipment 14A is connected or subsequently attached to the network, the mobility management module 60 performs itself authentication (which is transparent to the radiocommunication module 50) in a manner known to those skilled in the art. Once the authentication is made, the radiocommunication module 50 receives from the mobility management module 60 a temporary key only valid for the communication time with the user piece of equipment 14A. Upon receiving this key, exchanges between the user piece of equipment 14A and the radiocommunication module 50 are encrypted and “honest”. If each of these authentication attempts is failing, the user piece of equipment 14A is either rejected from the network (case of a rejected authentication at the user data management module 65), or prompted to be re-authenticated with the user data management module 65 (failure case with the mobility management module 60 or the radiocommunication module 50).

Following its attachment one of the base stations of a telecommunications system, the user piece of equipment receives from the base station a confirmation piece of information of its attachment state. By confirmation piece of information of the attachment state, it is meant:

a reply message indicating that the attachment occurred or not;

and/or a reply message indicating that the authentication occurred;

and/or a first communication indicating that the attachment occurred.

More precisely, in a 3GPP network, the attachment confirmation of the user piece of equipment is made the following way (see 3GPP TS 23.401 §5.3.2.1, FIG. 5.3.2.1-1): after sending an attachment request (see step 1) and once the identity management, authentication and ciphering procedures have been made, the user piece of equipment receives an accept message (“attach accept”, see step 18). Finally, the user piece of equipment confirms its attachment by sending a confirmation message (“attach complete” see step 22).

The attachment request can be the “RRC Connection Complete” request defined in the procedure of “RRC Connection Establishment” described in the specification 3GPP TS36.331 wherein the value of the “registeredMME” field has been filled with the identifier of the mobility management module 60 of the reference base station 12 of the user piece of equipment 14.

During an initial attachment of a user piece of equipment 14 to a base station 12, the mobility management module 60 generates and sends an identity of temporary mobile subscriber called S-TMSI (System Network Evolution-Temporary Mobile Subscriber Evolution) in the 3GPP standard which enables the user piece of equipment to remain attached to the base station 12 even if it does not communicate with it.

When the second identifier, sent by the user piece of equipment 14 is different from the first identifier, stored in the user data module 65, or that the user piece of equipment 14 is not authenticated from the user data module 65 or the mobility management module 60, the mobility management module 60 denies the user piece of equipment 14 to be attached to the base station 12 except for two particular cases.

A first case is relating to an urgency communication and a second case corresponds to the case where two base stations are bounded (“bounding cells”).

### b) EXAMPLE 2

### Urgency Communication

In the case of an urgency communication, any user piece of equipment 14 should be able to be attached to any base station 12 in order to communicate. In other words, a user piece of equipment 14 has to be able to communicate via a base station 12 the identifier of the mobility management module 60 of which is unknown to it.

In case of urgency, the attachment unit 110 of the user piece of equipment generates an attachment request comprising a piece of information about the urgent nature of the communication to be established and transmits it to the radiocommunication unit 100.

The radiocommunication unit 100 then sends said attachment request to the radiocommunication module 50 of the base station(s) in the coverage of which it is located.

The radiocommunication module 50 transmits the attachment request to the mobility management module 60 which thereby receives the piece of information about the urgent nature of the communication to be established (for example the “establishment cause” field) of a “RRC Connection Request” defined in the 3GPP standard) and authorises the attachment of the user piece of equipment 14 to the base station 12.

### c) EXAMPLE 3

### Bounded 12C1/12C2 Base Stations

This example is illustrated by FIG. 1 in which a first base station 12C1, comprising a first mobility management module 60 identified by a first identifier, is connected via a direct communication link L1, for example of the Internet Protocol (IP) type, to a second base station 12C2 comprising a second mobility management module 60 identified by a third identifier.

The attachment unit 110 of a user piece of equipment 14C2 located in the cell coverage of the second base station 12C2 generates in a step E1 an attachment request comprising a second identifier in order to be attached to the first base station 12C1.

The attachment request thus generated is then sent, in a step E2, by the radiocommunication unit 100 of the user piece of equipment 14C2 to the radiocommunication module 50 of the second base station 12C2.

Once the attachment request is received from the user piece of equipment 14C2, the radiocommunication module 50 of the second base station 12C2 analyses the second identifier and compares it to the third identifier.

Since the second identifier is different from the third identifier, the radiocommunication module 50 of the second base station 12C2 then compares it to the first identifier of the mobility management module 60 of the first base station 12C1 because it is connected to the second base station 12C2 and the mobility management module 60 of the first base station 12C1 is thus accessible via the communication link L1.

Since the third identifier is identical to the first identifier, the mobility management module 60 of the second base station 12C2 authenticates the user piece of equipment 14C2 from the user data module 65 of the first base station 12C1 via the serving gateway module 70 and the network gateway module 80 for data packets of the second base station 12C2, the IP communication link and the serving gateway module 70 and the network gateway module 80 for data packets of the first base station 12C1 in order to authorise the attachment of the user piece of equipment 14C2 to the second base station 12C2 such that it can communicate via the second base station 12C2, the IP communication link and the first base station 12C1, for example with another user piece of equipment 14C1 attached to the first base station 12C1.

### d) EXAMPLE 4

### Attachment to a Common Base Station 12D

When the base stations 12A, 12B, 12C1 and 12C2 are deactivated, it can be provided to attach the user piece of equipment 14A, 14B, 14C1 and 14C2 which were attached thereto to a common base station 12D, which is fixed in this example, of a common cell 10D illustrated in FIG. 2.

The attachment of the user piece of equipment 14A, 14B, 14C1 and 14C2 is made by conducting an attachment handover of their reference base station 12A, 12B, 12C1 and 12C2 to the common base station 12D. Such a handover is defined in the 3GPP standards and is thus known to those skilled in the art.

Such a case can happen, for example, when mobile base stations are mounted onto vehicles and the vehicles come back to a group point (camp) to be energised.

1. A method for attaching a user piece of equipment to a first base station of a wide-band telecommunications system, the first base station comprising a first mobility management module identified by a first identifier, the method comprising a step of receiving an attachment request, sent by said user piece of equipment, comprising a second identifier of a mobility management module and, when the second identifier is identical to the first identifier, a step of attaching the user piece of equipment to the first base station.

2. The method according to claim 1, wherein the attachment step comprises authenticating the user piece of equipment.

3. The method according to claim 1, wherein the attachment of the user piece of equipment to the first base station is denied when the second identifier is different from the first identifier.

4. The method according to claim 1, wherein the attachment of the user piece of equipment to the first base station is authorised when the second identifier is different from the first identifier and the first base station is connected via a communication link to a second base station comprising a second mobility management module identified by a third identifier, identical to the second identifier.

5. The method according to claim 1, wherein the attachment request further comprises a piece of information about the urgent or non-urgent nature of the attachment request, the attachment of the user piece of equipment to the first base station is authorised when the second identifier is different from the first identifier and the attachment request is of an urgent nature.

6. A method for attaching a user piece of equipment to a base station of a wide-band telecommunications system, said base station comprising a mobility management module, the method comprising a step of sending, by said user piece of equipment, an attachment request comprising an identifier of said mobility management module so as to attach the user piece of equipment to the base station.

7. The attachment method according to claim 6, comprising a step of generating from a user piece of equipment a request comprising at least one piece of information about a non-urgent or urgent nature of the communication, a step of sending from the user piece of equipment said request to the base station and a step of receiving a reply message sent by the base station, said reply message indicating that the attachment is made when the communication is urgent or comprising a confirmation piece of information of the attachment state when the communication is non-urgent.

8. A user piece of equipment comprising a radiocommunication unit, configured to communicate with a radiocommunication module of a base station of a wide-band telecommunications system, and an attachment unit, configured to generate an attachment request to a base station comprising a second identifier of a mobility management module and to send it to said base station, via the radiocommunication unit, for the purpose of attaching the user piece of equipment to the base station.

9. A base station of a wide-band telecommunications system, said base station comprising a mobility management module identified by a first identifier and a radiocommunication module configured to receive, from a user piece of equipment, an attachment request comprising a second identifier of a mobility management module, the mobility management module being configured to, when the second identifier is identical to the first identifier, attach the user piece of equipment to the base station.

10. The base station according to claim 9, further comprising a user data module, connected to the mobility management module, configured to store and manage data associated with user piece of equipment so as to authorise or not their attachment to the base station.

11. The base station according to claim 9, further comprising a serving gateway module, a network gateway module for data packets and/or an applicative module, said serving gateway module being configured to route data packets between the network gateway module for data packets and the radiocommunication module, said network gateway module for data packets being configured to communicate data packets with an entity external to the base station via a communication link, said applicative module being configured to exchange applicative data with an applicative unit of a user piece of equipment.

12. A system comprising at least one user piece of equipment according to claim 8 and at least one base station.

13. A non-transitory computer readable medium comprising instructions for implementing the method according to claim 1 when the program is run by at least one processor.

14. A non-transitory computer readable medium comprising instructions for implementing the method according to claim 6 when the program is run by at least one processor.
